(19) United States
(12) Patent Application Publication
(10) Pub. No.: US 2013/0108392 A1
(43) Pub. Date: May 2, 2013

(54) LOW PROFILE FASTENER ASSEMBLY

(71) Applicant: Arne Henriksen, JR., Algonquin, IL (US)

(72) Inventor: Arne Henriksen, JR., Algonquin, IL (US)

(73) Assignee: ENGINEERED COMPONENTS COMPANY, Elgin, IL (US)

(21) Appl. No.: 13/281,952

(22) Filed: Oct. 26, 2011

(51) Int. Cl. F16B 39/00; F16B 33/00

(52) U.S. Cl. 411/166; 411/366.2

(57) ABSTRACT

A fastener assembly including an internally threaded nut and an externally threaded screw for securing at least two materials together. The screw has an externally threaded shank and an enlarged head. The nut has a shank with a hole therein. The hole is internally threaded to threadingly receive the externally threaded shank of the screw. The nut has a diametrically enlarged head on an end of the shank opposite from an end with an opening of the hole. The enlarged head of the nut has a thickness not exceeding 0.10 inches. The underside of the enlarged head of the nut may have an annular recess formed therein surrounding the shank.

### BACKGROUND OF THE INVENTION

The present invention relates to a fastener assembly, and in particular to a fastener assembly including a nut with an enlarged head and an internally threaded shank.

Fastener assemblies including a nut with an enlarged encapsulated head have an internally threaded shank comprising a blind hole. The screw is threaded into the hole to secure the two fastener parts together and to clamp the fastened pieces together. These types of fasteners are sometimes referred to as T-nuts.

In some uses of fastener assemblies, such as in the construction of wall panels for truck bodies, the head of the nut portion of the fastener is exposed on the exterior of the truck. These head portions, which may have a thickness of 0.200 to 0.350 inches from their undersurface to their outer surface, protrude from the otherwise relatively flat wall of the truck, generally in rows or columns when the exterior side wall is secured to the interior wall structure of the truck body. The protruding heads prevent sheet-like advertising or informational signs, such as in the form of truck wraps, from being applied to the exterior side wall of the truck, or else cause a distracting and displeasing appearance.

Consequently, it can be seen that the need exists for a fastener assembly that can provide an attachment mechanism for truck body exterior side walls, yet will allow for the use of sheet-like advertisements known as full wrap graphics or informational signs to be applied to the exterior side wall without causing a distracting or displeasing appearance.

### SUMMARY OF THE INVENTION

In an embodiment, the present invention provides a fastener assembly including an externally threaded screw and an internally threaded nut for use in securing at least two materials together, wherein a head of the nut portion of the fastener assembly has a low profile. This means that the thickness of the head of the nut which protrudes from the exterior surface of the truck body is much thinner than conventional T-nut heads, and is on the order of no greater than about 0.080 to 0.150 inches, and preferably about 0.100 inches.

The underside of the head of the nut, in an embodiment, includes an annular recess extending around the shank of the nut which results in an annular lip being formed on the lower surface at the circumference of the head.

A seal member, such as an O-ring, may be carried on the shank of the nut. The seal member will be pressed into the annular recess as the fastener is tightened to provide a water tight seal between the lower surface of the head and the exterior surface of the truck body. This seal member will prevent water, such as rain, from entering the truck body at the location of the fasteners.

To secure the nut in place in the wall of the truck body, and to prevent rotation of the nut as the screw is tightened into the nut, the nut may be provided with anti-rotation protrusions. These protrusions may take the form of ribs or ridges provided on the shank of the nut. The ribs may be arranged parallel to the axis of the screw which is inserted into the nut, or the ribs may be angled relative to the axis.

The outer surface of the nut portion of the fastener may be provided with a salt spray protector in the form of a liquid sealant that will dry with a very thin thickness so as not to meaningfully increase the thickness of the head portion.

### BRIEF DESCRIPTION OF THE DRAWINGS

The features of the present invention which are believed to be novel, are set forth with particularity in the appended claims. The invention, together with further objects and advantages, may best be understood by reference to the following description taken in conjunction with the accompanying drawings, in the several Figures in which like reference numerals identify like elements, and in which:

FIG. 1 is a cross-sectional view of a two component wall structure showing the low-profile fastener assembly in place.

FIG. 2 is a perspective view of a disassembled low-profile fastener assembly.

FIG. 3 is a side sectional view of the nut portion of the fastener assembly of FIG. 1.

FIG. 4 is a side elevational view of an alternate embodiment of the nut portion of the fastener assembly of FIG. 2.

FIG. 5 is an end elevational view of the nut portion of the fastener assembly of FIG. 4, taken from the left side.

FIG. 6 is a side sectional view of the nut portion of the fastener assembly of FIG. 5, taken generally along the line VI-VI.

FIG. 7 is a perspective view of the nut portion of the fastener assembly of FIG. 4.

### DETAILED DESCRIPTION OF THE PREFERRED EMBODIMENTS

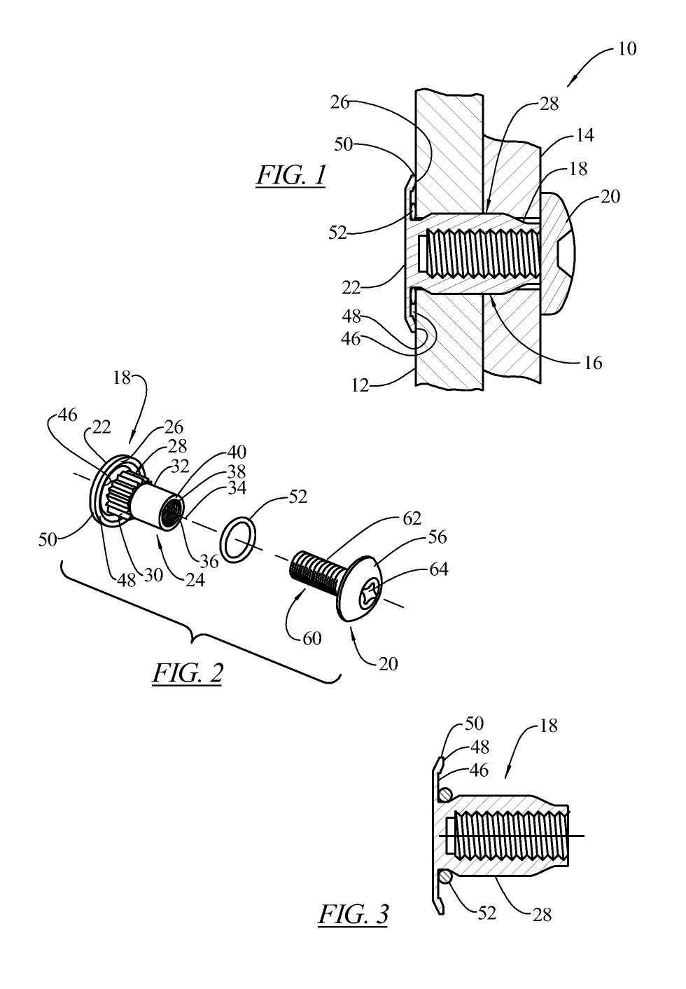

FIG. 1 illustrates a portion of a structure 10 (such as a container, portable shelter or truck body) in which a material forming a first structural component 12 such as a wall panel is secured to a second structural component 14 such as an extrusion by means of a plurality of fastener assemblies 16. Although only two layers of structural components are shown, any number of two or greater structural components may be secured together with the fastener assembly 16 of the present invention.

As shown in FIGS. 1 and 2, each of the fastener assemblies 16 includes a first fastener member 18 and a second fastener member 20. The first fastener member 18 may be in the form of a T-nut which includes a generally disc-shaped head portion 22. A generally cylindrical shank portion or post 24 is secured to, and extends from, an underside 26 of the head portion 22. The shank portion 24 may be provided with an anti-rotation structure 28 in the form of a plurality of longitudinal ridges 30. The longitudinal ridges 30 are formed on a portion of the length of an outer peripheral surface 32 of the shank portion 24, and extend generally parallel to a longitudinal axis 34 of the shank portion 24. The longitudinal ridges 30 may have a constant height along their entire length.

The shank portion 24 is provided with an internally threaded longitudinal bore 36 comprising a blind hole with an opening 38 at a free end 40 opposite the head portion 22. The outer peripheral surface 32 of the shank portion 24 near the end 40 has a smooth cylindrical shape with an outer diameter smaller than a width dimension of the anti-rotation structure 28.

The underside 26 of the first fastener member 18 has an annular recess 46 surrounding the shank portion 24 which forms an annular lip 48 at a periphery 50 of the head portion 22. When the fastener assembly 16 is tightened into position, a seal member 52 shown in the form of an O-ring which may be carried on the shank portion 24 will be squeezed between the underside 26 of the head portion 22 and the first structural component 12, which may be the exterior surface of a truck body. In a preferred embodiment, the O-ring 52 has a diameter greater than a depth of the annular recess 46. For example, the annular recess 46 may have a depth of about 0.025 inches and the O-ring may have a diameter of about 0.0625 inches. This will cause the O-ring to flatten out, as shown in FIG. 1 when the underside 26 of the head portion 22 presses against the surface of the first structural component 12. In this manner, water, such as rain, will be prevented from entering the truck body at the location of the fasteners.

While the underside 26 of the head portion 22 may be made without any recess, if a seal member 52 is used with such a first fastener member 18, the seal member may be squeezed to the point where it extends beyond the outer periphery of the head portion 22 potentially causing an unsightly appearance. Further, by using an annular recess 46 forming an annular lip 48, there are two concentric seal points, the lip engagement with the first structural member 12 and the O-ring engagement with the first structural member. This improves the sealing characteristics.

The second fastener member 20, which may be a screw, is provided with a generally cylindrical shank portion 60. The head portion of the screw may be a countersink head, a round head, pan head, etc., depending on the application involved. The shank portion 60 is provided with external threads 62 that may extend along the entire length of the shank portion 60, and is adapted to threadingly engage with the internal bore 36 of the first fastener member 18. An outer side of the head portion 56 of the second fastener member 20 may be provided with a recessed portion 64 that is adapted to receive a tool for rotationally driving the second fastener member. The recessed portion 64 as shown is adapted to receive a TORX.RTM. driving tool, but it is contemplated that the head portion 56 can be adapted or shaped to receive any suitable driving tool, such as a screwdriver, allen wrench or socket wrench.

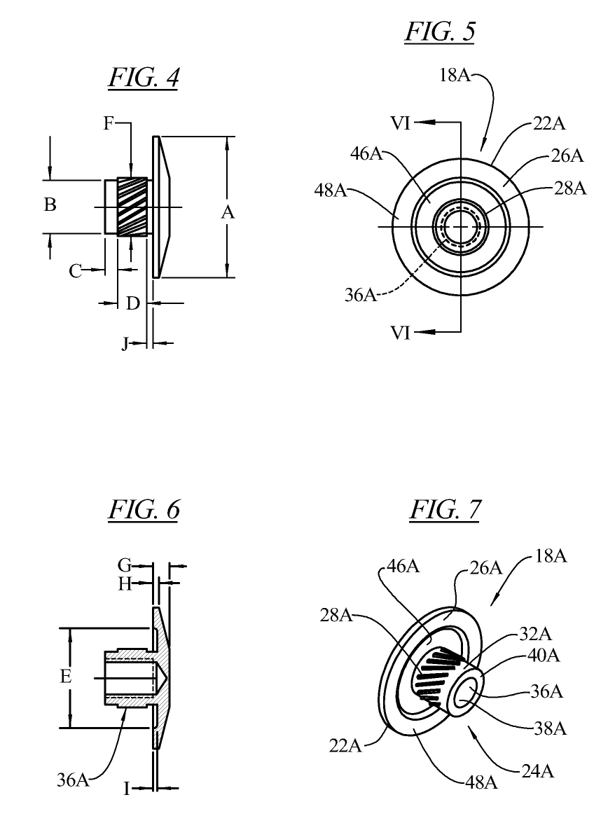

In FIGS. 4-7 a second embodiment of the first fastener member is shown at 18A. This embodiment varies from the embodiment shown in FIGS. 1-3 in that the ribs 30A are angled relative to the axis of the shank portion 24A and the shank portion is relatively shorter than the shank portion 24 shown in FIGS. 1-3. In all other respects the construction of the first fastener member 18A in FIGS. 4-7 is the same as that shown in FIGS. 1-3, namely, there is an annular recess 46 extending around the shank portion 24A in the undersurface 26A of the head portion 22A forming an annular lip 48A at the periphery 50A of the head portion. Other similar elements have the same reference number applied as in FIGS. 1-3, with the addition of an A suffix.

In operation, the first fastener member 18 is inserted into a bore 66 in the structural component 12, as shown in FIG. 1. The bore 66 has a diameter that is slightly less than the diameter of the anti-rotational structure 28. The longitudinal ridges 30 frictionally engage the inner surface of the bore 66. The smooth cylindrical shape of the outer peripheral surface 32 of the shank portion 24 is smaller in diameter than the bore 66, allowing the first fastener member 18 to be easily inserted into the bore.

After the first fastener member 18 has been inserted into the first structural component 12, the second fastener member 20 is then inserted through an aligned bore 68 in the second structural component 14, and a driving tool is used to rotationally drive the second fastener member 20, thus causing the threaded shank portion 60 of the second fastener member to threadingly engage the threaded inner bore 36 of the first fastener member 18. The frictional engagement of the anti-rotation structure 28 with the inner surface of the bore 68 prevents rotational movement of the first fastener members 18 with respect to the bore 68 of the first structural component 12.

The triangular configuration of the longitudinal ridges 30 (see FIG. 2) also allows the first fastener members 18 to be non-destructively removed from the first structural component 12 upon application of a significant axial force. This advantage is particularly important in applications where disassembly and reassembly are required, such as in containers and portable shelters.

The low profile (thickness) of the head portion 22, 22A results in a nearly smooth surface for the first structural member 12, thereby allowing the surface of the first structural member to be covered with thin, sheet-like advertisements or informational signs, such as truck wraps, without causing any unsightly bumps at the locations of the fasteners assemblies 16. The low profile also allows the sheet-like advertisements or informational signs to adhere to the surface of the first structural member without the formation of bubbles or gaps which might detrimentally affect the adherence.

To provide protection for the first fastener components 18, they may be coated with a salt spray protector which will seal the surfaces of the first fastener components, and particularly the head portion, from salt spray or other corrosive materials that might lead to rusting or deterioration of the first fastener components.

The outer surface of the head portion 22, 22A may be painted white or other color, depending on the covering to be placed over the first structural member and the fastener assembly 16 so that if the sheet-like advertisement or informational sign is scraped or torn in the location of the fastener assembly, the fastener assembly will not be readily visible.

In a particular embodiment, such as shown in FIGS. 4 and 6, the first fastener member 18A may have the following approximate dimensions: Diameter (A) of head 22A—0.850 inches. Diameter (B) of smooth portion 32A of shank 24A—0.335 inches. Length (C) of smooth portion 32A of shank 24A—0.135 inches. Axial length (D) of anti-rotational ribs 30A—0.145 inches. Outer diameter (E) of annular recess 46A—0.650 inches. Diameter (F) at tops of anti-rotational ribs 30A—0.375 inches. Thickness (G) of head portion 22A—0.100 inches. Thickness (H) of head portion 22A at periphery—0.035 inches. Depth (I) of annular recess 46A—0.025 inches. Distance (J) from end of anti-rotational ribs 30A to the underside 26A of the head portion 18A—0.010 inches. Threaded recess 36A sized to receive a ¼ inch—20 threaded screw.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fastener assembly including an externally threaded screw and an internally threaded nut for use in securing at least two materials together, comprising:
said screw having an externally threaded shank and an enlarged head,
said nut having a shank with a blind hole therein, said blind hole being internally threaded to threadingly receive said externally threaded shank of said screw,
said nut having a diametrically enlarged head on an end of said shank opposite from an end with an opening of said blind hole,
said enlarged head of said nut having a thickness not exceeding 0.10 inches.

2. A fastener assembly according to claim 1, including a seal member located on an underside of the enlarged head.

3. A fastener assembly according to claim 2, wherein the seal member comprises an O-ring.

4. A fastener assembly according to claim 1, including an annular recess formed in a lower surface of the enlarged head surrounding the shank.

5. A fastener assembly according to claim 4, wherein the annular recess has a depth of about 0.025 inches.

6. A fastener assembly according to claim 1, including a salt spray protector applied to an outer surface of said enlarged head.

7. A fastener assembly according to claim 1, wherein an outer annular lip is provided at a periphery of an underside of the head.

8. A fastener assembly according to claim 1, including an anti-rotation structure on the shank of the nut.

9. The fastener assembly according to claim 8, wherein said anti-rotation structure includes a plurality of longitudinal ridges disposed on at least part of a length of an outer surface of said shank portion extending in a direction generally parallel to said longitudinal axis of said shank portion.

10. The fastener assembly according to claim 9, wherein said longitudinal ridges extend along a portion of said shank of said nut and terminate short of said end of said nut with said opening of said blind hole.

11. A fastener assembly including a first fastener member and a second fastener member for use in securing at least two materials together, comprising:
said second fastener member having an externally threaded shank and an enlarged head,
said first fastener member having a shank with a hole therein, said hole being internally threaded to threadingly receive said externally threaded shank of said second fastener member,
said first fastener member having a diametrically enlarged head on an end of said shank opposite from an end with an opening of said hole,
said enlarged head of said first fastener member having a thickness not exceeding 0.10 inches,
an annular recess formed in a lower surface of the enlarged head surrounding the shank of the first fastener member.

12. A fastener assembly according to claim 11, wherein said first fastener is a T-nut and said second fastener is a screw.

13. A fastener assembly according to claim 11, including a seal member located on an underside of the enlarged head of the first fastener member.

14. A fastener assembly according to claim 13, wherein the seal member comprises an O-ring.

15. A fastener assembly according to claim 11, including a salt spray protector applied to an outer surface of said enlarged head of the first fastener member.

16. A fastener assembly according to claim 11, wherein an outer annular lip is provided at a periphery of an underside of the head.

17. A fastener assembly according to claim 11, including an anti-rotation structure on the shank of the first fastener member.

18. A fastener assembly including a T-nut and a screw for use in securing at least two materials together, comprising:
said screw having an externally threaded shank and an enlarged head,
said T-nut having a shank with a hole therein, said hole being internally threaded to threadingly receive said externally threaded shank of said screw,
said T-nut having a diametrically enlarged head on an end of said shank opposite from an end with an opening of said hole,
said enlarged head of said T-nut having a thickness not exceeding 0.10 inches,
an annular recess formed in a lower surface of the enlarged head surrounding the shank of the T-nut, such that an outer annular lip is formed at a periphery of an underside of the head,
a seal member in the form of an O-ring located on an underside of the enlarged head of the T-nut,

19. A fastener assembly according to claim 17, including a salt spray protector applied to an outer surface of said enlarged head of the first fastener member.

20. A fastener assembly according to claim 17, including an anti-rotation structure on the shank of the first fastener member.
